(19) United States
(12) Patent Application Publication
(10) Pub. No.: US 2011/0217681 A1
(43) Pub. Date: Sep. 8, 2011

(54) SENSOR NETWORK FOR INCENTIVIZING BEHAVIORAL ACTIONS

(76) Inventor: Brian Krejcarek, Portland, OR (US)

(21) Appl. No.: 13/039,193

(22) Filed: Mar. 2, 2011

Related U.S. Application Data
(60) Provisional application No. 61/310,189, filed on Mar. 3, 2010.
(60) Provisional application No. 61/351,734, filed on Jun. 4, 2010.
(60) Provisional application No. 61/459,235, filed on Dec. 9, 2010.

(51) Int. Cl. G09B 19/00

(52) U.S. Cl. 434/236

(57) ABSTRACT

Various embodiments are described herein related to positively reinforcing user behavior based on a user behavioral action performed by a user and detected by one or more sensors. For example, one disclosed embodiment relates to a behavior reward system including a wireless sensor configured to transmit behavior data generated in response to an interrupt generated by an accelerometer included in the wireless sensor and a server computing device including a data-holding subsystem configured to hold instructions executable by a logic subsystem, the instructions being configured to determine whether the behavior data indicates that the user behavioral action was performed and if the behavior data indicates that the user behavioral action was performed, supply a reward offer to the user.

### CROSS REFERENCE TO RELATED APPLICATIONS

This application claims priority to U.S. Provisional Patent Application Ser. No. 61/310,189, titled “Sensor Network for a Behavior Reward System” and filed on Mar. 3, 2010; to U.S. Provisional Patent Application Ser. No. 61/351,734, titled “Sensor Network for a Behavior Reward System” and filed on Jun. 4, 2010; and to U.S. Provisional Patent Application Ser. No. 61/459,235, titled “Personal Activity Measurement and Behavior Storage Device and Methods to Achieve Very Low Power and Low Cost,” and filed on Dec. 9, 2010, the entireties of which are hereby incorporated herein by reference for all purposes.

### BACKGROUND

Making changes to personal habits can be difficult. Some approaches use rigorous tracking. For example, an individual may track her behavior in a journal, logging activities to be encouraged or discouraged, so that she may review her progress over time. However, such approaches can be tedious, leading to neglect and avoidance of the behavior, so that the individual may fall back into her previous behavioral pattern. Further, tracking and logging behaviors may inhibit behavioral change where the changes are incrementally small and where the individual is discouraged by the apparent lack of progress.

### SUMMARY

Various embodiments are described herein related to a behavior reward system configured to positively reinforce user behavior based on a user behavioral action performed by a user. For example, one disclosed embodiment relates to a behavior reward system including a wireless sensor configured to transmit behavior data generated in response to an interrupt generated by an accelerometer included in the wireless sensor and a server computing device including a data-holding subsystem configured to hold instructions executable by a logic subsystem. In one example, the wireless sensor is configured to determine whether a combination of detected events and conditions indicate that the user behavioral action has been performed. In other examples, the determination may occur at the server computing device, or at both the wireless sensor and the server computing device. In one disclosed embodiment, the server computing device is configured to supply an offer to the user if the user behavioral action was performed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an embodiment of a behavior reward system.

FIG. 2 shows a flow chart illustrating an embodiment of a method for detecting a user behavioral action using a wireless sensor.

FIG. 3 shows a flow chart illustrating an embodiment of a method of detecting a bottle dispense action using a wireless sensor.

FIG. 4 shows a flow chart illustrating another embodiment of a method of detecting a bottle dispense action using a wireless sensor.

FIG. 5 shows a flow chart illustrating an embodiment of a method for detecting a dental floss dispense action using a wireless sensor.

FIG. 6 shows a flow chart illustrating an embodiment of a method for detecting sustained movements using a wireless sensor including an accelerometer.

FIG. 7 shows a flow chart illustrating an embodiment of a method for detecting a user behavioral action from detected motion and location information.

FIG. 8 shows a flow chart illustrating an embodiment of a method of correlating a user identity with a user behavioral action detected by a sensor.

FIG. 9 schematically shows an embodiment of a sensor and an embodiment of a user tag for use with the behavior reward system of FIG. 1.

FIG. 10 schematically shows another embodiment of a sensor including a flexible substrate and a flexible power supply for use with the behavior reward system of FIG. 1.

FIG. 11 schematically shows an embodiment of a sticker-style sensor for use with the behavior reward system of FIG. 1.

FIG. 12 schematically shows an embodiment of a credit-card style sensor for use with the behavior reward system of FIG. 1.

FIG. 13A shows a portion of a flow chart illustrating an embodiment of a method of reinforcing a user behavior based on behavioral action data received from a sensor.

FIG. 13B shows another portion of the flow chart of FIG. 13A.

### DETAILED DESCRIPTION

As explained above, making changes to personal habits can be difficult. Tracking and logging behaviors may inhibit behavioral change where the changes are incrementally small and where the individual is discouraged by the apparent lack of progress. Thus, various embodiments of methods and hardware are described herein that relate to positively reinforcing a behavioral action based on information received from sensors configured to detect the action. For example, in one embodiment, a method for positively reinforcing a user behavior comprises, at a server computing device, receiving behavior data from a sensor configured to sense a user behavioral action. Responsive to the behavior data, the method further comprises using a logic subsystem of the server computing device to supply an offer configured to reward the user behavioral action and sending the offer to the user.

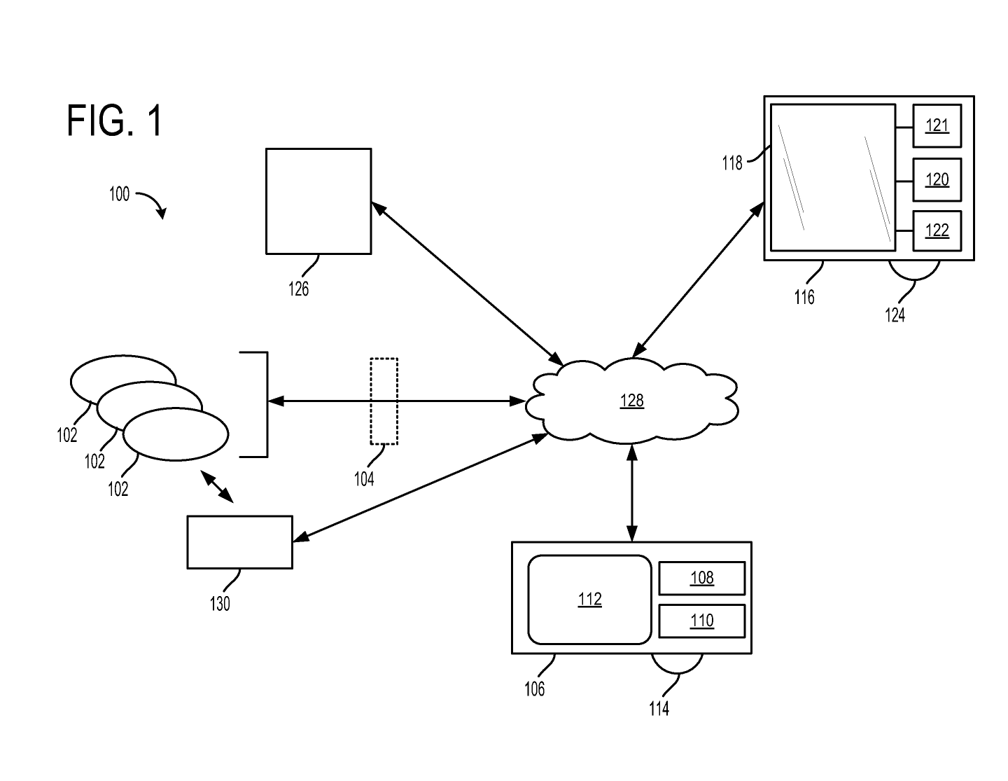

For example, FIG. 1 schematically shows an embodiment of a behavior reward system 100. Behavior reward system 100 comprises a plurality of sensors 102 configured to detect a user behavioral action and transmit messages related to the user behavioral action to server computing device 106. In some embodiments, an optional gateway computing device 104 may relay messages between sensors 102 and server computing device 106. For example, in some embodiments, gateway computing device 104 may be configured to communicate with various sensors 102 installed in and around a user's residence via wireless and/or wired communication. Further, in some embodiments, gateway computing device 104 may be configured to provide location information for one or more sensors 102, such as by providing a media access control (MAC) address registered to a particular physical location. In some embodiments, gateway computing device 104 may be a computing device configured to reside in a particular location (such as a user's home). In some other embodiments, client computing device 116 may be configured to perform the function of gateway computing device 104. In such embodiments, for example, a user's mobile phone may be configured to receive signals from sensor 102 and transmit them to server computing device 106.

Server computing device 106 manages behavior reward system 100, and may include one or more servers and/or a cloud computing environment. Server computing device 106 includes a behavior reward module 112, behavior reward module 112 being implemented via instructions stored in data-holding subsystem 110 and executed by logic subsystem 108. Server computing device 106 is configured to read from and/or write to removable computer readable media 114. Behavior reward module 112 is configured to receive behavioral action data from sensors 102, supply an offer responsive to the behavioral action data, and send the offer to client computing device 116 for presentation to the user. In some embodiments, behavior reward module 112 may be configured to identify a particular user who performed the user behavioral action detected by sensor 102 based on messages received from a user tag 130 and/or from a particular sensor 102.

Behavior reward module 112 may be configured to send portions of the behavioral action data to, and/or to receive offers and offer-related messages from, one or more offering parties 126. Offering parties 126 are parties who choose to provide a reward and/or an incentive to the user in response to the user's behavioral action. Some non-limiting examples of offering parties 126 include employers, social affiliates, and goods and services providers. For example, in one scenario, an offering party 126 may be the user's employer, who may offer the user a reward in response to a sensed bicycle commuting trip made by the user to incentivize bicycle commuting. In another scenario, an offering party 126 may be a personal hygiene product manufacturer, who may offer the user a coupon for dental floss in response to sensed oral hygiene behavior of the user. It will be understood that any suitable offering party 126 may make offers to the user in response to sensed behavioral action via behavior reward system 100 without departing from the scope of the present disclosure.

Offers may be generated at offering party 126 and/or at server computing device 106. Regardless of where the offer is generated, server computing device 106 supplies offers to the user, receives offer selections (e.g., offer acceptances or offers by the user) from the user, and may manage message traffic between offering party 126 and client computing device 116.

While the examples described herein refer to an offer being communicated to the user and to the user communicating an offer selection manifesting acceptance to the offering party, it will be appreciated that other suitable exchanges of agreements may be performed without departing from the scope of the present disclosure. For example, in some embodiments, offering party 126 may provide a promotional opportunity to the user via server computing device 106 that invites the user to make an offer, via an offer selection of the user, which offering party 126 may accept or reject.

As another example, in some embodiments, offering party 126 may offer the user points in a game in which the user participates. For example, sensor 102 and/or user tag 130 may be configured to be used with a game. Framing the performance of a user behavioral action in the context of a game may make the experience more enjoyable for the user and may incentivize the behavioral change. For example, in one scenario, sensor 102 and/or user tag 130 may be affixed or included in a game controller or a toy. A child interacting with the toy or game controller when performing the user behavioral action may be rewarded with an offer of advancement within the game. For example, the child may be presented with offers for entry into a new game level, game currency exchangeable for game gear, upgraded game features, game expansions, enhanced game avatars, etc. In another scenario, a user may participate in a group challenge game, where the user's performance of the user behavioral action may be displayed to other members of the group. In such a scenario, sensor 102 and/or user tag 130 may be operatively coupled with a game token with which the user interacts when performing the user behavioral action. Detection of the user behavioral action may advance the user up a leaderboard and may present the user with suitable offers that may enhance the user's enjoyment of the game, and that may thus encourage the behavioral change.

Offers are supplied by server computing device 106 to client computing device 116. Client computing device 116 includes a logic subsystem 120, a data-holding subsystem 122, and a display subsystem 118, and is configured to read from and/or write to removable computer readable media 124. Logic subsystem 120 is configured to execute instructions stored in the data-holding subsystem 122 to implement the instructions for performing various methods described herein. Client computing device 116 may be any suitable computing device. Non-limiting examples of client computing device 116 include a mobile and/or wireless computing device, a networked computer, or a kiosk-type device.

Client computing device 116 also includes a user interface 121 for receiving input from the user and for displaying information to the user. For example, in one scenario, a user may view information about the user's energy consumption and savings, as detected by sensors 102, via user interface 121. A score and/or a score value related to the sensed behavioral action of the user may be presented to the user via user interface 121. User interface 121 may also present historical information for the user's sensed behavioral actions (e.g., accumulated scores and/or score values, instances of one or more sensed behavioral actions over a time interval, etc.) that may incentivize the behavioral action and/or inform the user of potential “backsliding” into old habits. User interface 121 may be presented in any suitable way. Non-limiting examples of user interface 121 include user-customizable and/or personalized web pages, SMS text messages, TWITTER-style feeds, and email alerts displayed by client computing device 116.

The user may receive and select offers via user interface 121. The user may also configure aspects of behavior reward module 112 via user interface 121. For example, a user may associate a score with a behavioral action, such as assigning a score for commuting a predetermined distance by bicycle. In some embodiments, user interface 121 may be presented via display subsystem 118 though it will be appreciated that user interface 121 may be presented to a user via any suitable presentation hardware.

As shown in FIG. 1, communication among the various computing devices of behavior reward system 100 is handled by network 128. It will be understood that sensors 102, gateway computing device 104, server computing device 106, client computing device 116, and computing devices included in offering parties 126 may include suitable communication subsystems configured to communicatively couple with one or more other computing devices. Such communication subsystems may include wired and/or wireless communication devices compatible with one or more different communication protocols. Some non-limiting examples include wireless telephone networks (e.g., cellphone networks), a wired local area network (LAN), a wired wide area network (WAN), wireless LANs and/or WANs, and so on. In some embodiments, the communication subsystems may allow the computing devices to send and/or receive messages to and/or from other computing devices via the Internet.

Sensor 102 may be removably attached to an object (e.g., a sensor sticker affixed to a tube of toothpaste), or otherwise compact and portable (e.g., a sensor affixed to a hub of a bicycle). In some embodiments, sensor 102 may be configured to encourage interaction with sensor 102 to perform a particular user behavioral action. For example, in some embodiments, sensor 102 and/or user tag 130 may be included in or attached to a toy to encourage a child to perform the user behavioral action. Thus, in one scenario, the toy including sensor 102 may be used by the child as a part of a game in which performance of a particular user behavioral action may be rewarded with an offer of points, advancement in the game, etc.

In some embodiments, sensor 102 includes a wireless sensor configured to wirelessly transmit messages to server computing device 106. Because such sensors may need to operate in a low power state to extend battery life or to utilize a smaller power source, in some embodiments, sensor 102 may include a logic subsystem configured to remain in a standby state until it receives an interrupt generated by a detector included in sensor 102.

For example, in some embodiments, sensor 102 includes an accelerometer configured to generate an interrupt in response to a detected initiation of a motion event. Receipt of the interrupt causes the sensor to transition from a standby state to an active state. Once sensor 102 is in the active state, sensor 102 determines whether detector information received from the accelerometer indicates that the user behavioral action has been performed. If the detected event is determined to be the user behavioral action, sensor 102 transmits behavior data associated with the user behavioral action to server computing device 106; if the sensor determines that the detected event is not the user behavioral action the sensor avoids a transmission event. Thus, in some embodiments, sensor 102 may remain in a lower power standby state until an event is detected, transition to a higher power active state to determine that the user behavioral action was performed, transmit a performance message, and return to the lower power standby state, which may conserve power for the device.

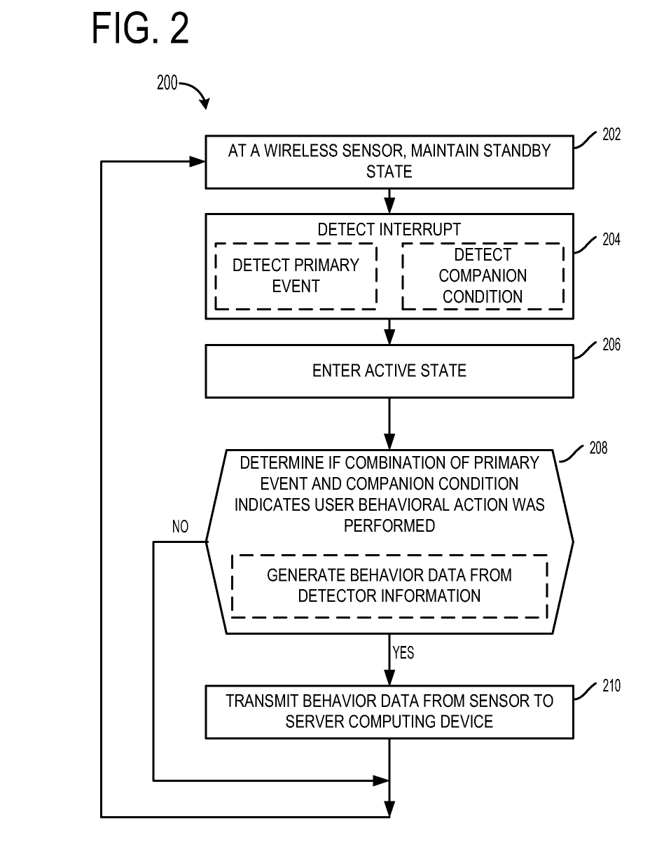

FIG. 2 shows a flow chart illustrating a method 200 for detecting a user behavioral action using a sensor coupled with an object with which a user interacts when performing the user behavioral action. Method 200 includes, at 202, maintaining a standby state at the sensor. In some embodiments, the standby condition may be a low-power state, such as a “sleep” state, wherein various components of the sensor, such as the transmitter, may be inactive.

At 204, method 200 includes detecting an interrupt. For example, an accelerometer may detect a force associated with a motion event and generate an interrupt (for example, a transition from a lower voltage state to a higher voltage state) causing the sensor to transition from a standby state to an active state.

In the embodiment shown in FIG. 2, detection of the interrupt may be concurrent with detection of a primary event and/or a companion condition, though it will be appreciated that the time(s) of detection should not be so limited. The detection of a particular combination of primary event and companion condition signifies that a particular user behavioral action is being performed, allowing the sensor and/or the server computing device to discern a rewardable behavior from detector signals resulting from unrelated activity. As used herein, a primary event includes physical events recognized by a detector included in the sensor. For example, a motion event detected by an accelerometer may be a primary motion event, or a sound event detected by an audio detector may be a primary sound event. Companion conditions include circumstances corroborating performance of the user behavioral action. It will be appreciated that companion conditions may be any suitable condition. For example, a companion condition may include one or more of timing information, user identification information (such as provided by an interaction between a sensor and a user tag), location information, and additional events detected by one or more detectors included in the sensor. Thus, in some embodiments, a companion condition may include a prescribed pattern of motion events detected by an accelerometer. Detection of the primary event and the companion condition permit the sensor and/or the server computing device to distinguish performance of a user behavioral action from other activity detected by the sensor. For example, in a scenario where the rewardable user behavioral action is taking medication in a timely manner, the recognition of a particular combination of events and conditions allows an actual medicine bottle dispense action to be distinguished from a dropped bottle action.

At 206, method 200 includes entering an active state, and, at 208, determining if the combination of primary event and companion condition indicates that the user behavioral action was performed. In the embodiment shown in FIG. 2, if it is judged that the user behavioral action was performed, the sensor transmits a message including the behavior data to the server computing device at 210 and returns to the standby state. If it is judged that the user behavioral behavior was not performed, the sensor returns to the standby state without transmitting the message. In some embodiments, the sensor may remain in the active state for a predetermined time interval prior to returning to the standby state. If another event is not detected within the predetermined time interval, the sensor returns to the standby state. Leaving the sensor active for such time may allow the sensor to capture a subsequent event without having to power-up the sensor again, potentially reducing power consumption during the power-up event.

In some embodiments, determining if the user behavioral action was performed includes generating behavior data from the detector information. The behavior data may include any suitable data received from the detector and/or derived from the detector information, including detector information generated by the detector that reflects the detected event. For example, a three-axis accelerometer may measure a direction and magnitude of a force and generate accelerometer data including the direction and magnitude measurements for each of the three axes. In this example, the behavior data may include portions of the accelerometer data generated by the accelerometer.

In some embodiments, the behavior data may contribute to a determination of a particular intensity of the user behavioral action, which may be used in a determination of a particular offer to be supplied to a user. In some non-limiting scenarios, the behavior data may include force information associated with how hard a user swings a sensor-enabled baseball bat or kicks a sensor-enabled soccer ball. In turn, the user may receive an offer in response to time spent playing soccer and/or in response to achieving a performance goal in that sport that is detectable at least in part by such intensity determinations.

Additionally or alternatively, such intensity determinations may be generated from behavior data relative to configurable thresholds used to identify performance of the user behavioral action. For example, in a scenario where the sensor is configured to transmit a count of a number of interrupts received from an accelerometer that exceed one or more configurable force thresholds (such as in a pedometer application), the behavior data may include the count of those interrupts generated with respect to each configurable force threshold. Thus, in one non-limiting pedometer application, the behavior data may transmit a first count of interrupts exceeding a first configurable force threshold associated with walking and a second count of interrupts exceeding a second configurable force threshold associated with running.

In some embodiments, the behavior data may include suitable metadata for the sensor, such as timing information for the primary event and/or the companion condition and user identification information configured to identify a particular user with whom the user behavioral action should be associated. Accordingly, it will be appreciated that the behavior data may include any suitable information for identifying the user performing the user behavioral action and/or any suitable information describing a quantity and/or a quality of the user behavioral action.

While the embodiment shown in FIG. 2 describes an embodiment where determination of whether the user behavioral action was performed occurs at the sensor, it will be understood that, in some embodiments, determination of whether the user behavioral action was performed may be divided between the sensor and the server computing device or may occur at the server computing device alone. For example, in a scenario where the sensor is used as a pedometer, the sensor may be configured to transmit a count of a number of interrupts received from an accelerometer that are judged to have resulted from steps taken by the user, and the server computing device may be configured to determine that the user behavioral action has been performed when the count exceeds a predetermined number corresponding to a distance and/or step goal.

As explained above, the sensor may include an accelerometer configured to detect motion in the sensor resulting from user interaction with an object to which the sensor is affixed or otherwise operatively connected. In such embodiments, the primary event may include a primary motion event detected by the accelerometer. Thus, when a user initiates a movement of the object connected to the sensor, an interrupt is generated by the accelerometer, causing the sensor to enter an active state and evaluate accelerometer information provided by the accelerometer. However, because the object may be moved for reasons other than performance of the user behavioral action, the sensor may be configured to distinguish among motion events detected by the accelerometer. For example, a dropped object may experience a shock force detected by the accelerometer that is characterized by a force in excess of 1.3 g. Thus, the sensor may be configured to ignore such shock forces, and determine that the user behavioral action was performed if the primary motion event is characterized by a force of less than a predetermined drop shock force. In such embodiments, the behavior data may be generated from and/or include accelerometer information (e.g. force and direction information) received from the accelerometer. Further, the companion condition may include a companion motion detected by the accelerometer, so that a particular combination of motion events detected by the accelerometer signifies the performance of a particular user behavioral action.

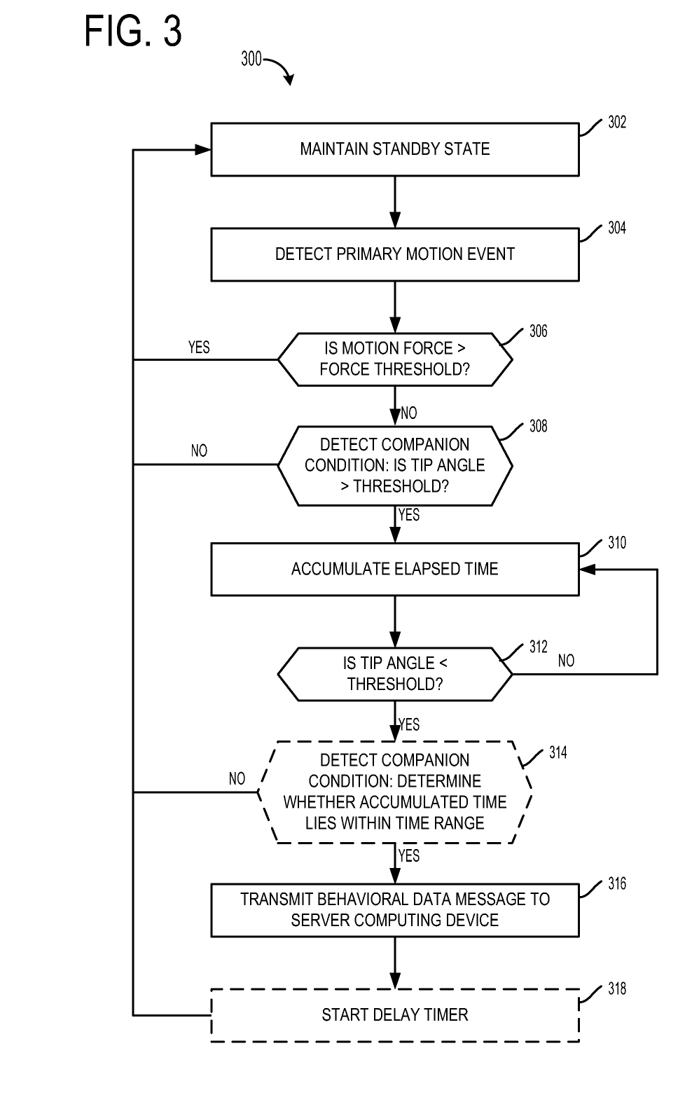

FIGS. 3-5 show flow charts illustrating embodiments of methods for detecting a user behavioral action using a sensor including an accelerometer. While the examples described below detect user behavioral action using primary events detected by an accelerometer and/or companion conditions detected with reference to accelerometer information, it will be appreciated that other suitable detectors may be used to detect primary events and/or companion conditions. For example, photosensors and/or acoustic sensors may be used to detect companion conditions to reduce an occurrence of false positive determination that a user behavioral action has occurred that may result from a faulty accelerometer.

For example, FIG. 3 shows a flow chart illustrating an embodiment of a method 300 of detecting a bottle dispense action. This may permit users to track consumption of water, medication, etc., over time. A sensor comprising an accelerometer for identifying dispensing actions may be operatively coupled to a bottle. While method 300 is described with respect to a bottle below, it will be appreciated that the sensor may be coupled to any suitable container within the scope of the present disclosure. In one scenario, such a sensor may be packaged in a button-like enclosure affixed to any suitable portion of the bottle, such as a lid, a sidewall, or a base of the bottle.

Method 300 includes, at 302, maintaining a standby condition for the sensor. At 304, method 300 includes detecting a primary motion event in the bottle with an accelerometer included in the sensor. For example, in some embodiments, an interrupt to a processor of the sensor is generated when the bottle is moved.

At 306, method 300 includes determining whether the motion force exceeds a predetermined force threshold. This may identify unintentional movements, such as drops. For example, in one embodiment, the sensor may be configured such that a force exceeding 1.3 g along any axis is assumed to be an unintentional drop. In the example shown in FIG. 3, if the force exceeds the force threshold, method 300 returns to the standby state at 302. If the force does not exceed the force threshold, method 300 continues to 308.

At 308, method 300 includes detecting a companion condition including a companion motion by determining whether the tip angle exceeds a threshold angle identifying a bottle dispensing action. The threshold angle may be a predetermined value or may be determined from a heuristic related to the type and/or size of the bottle. If the tip angle does not exceed the threshold angle, it may be assumed that the bottle is not in a dispensing position and method 300 returns to the standby state at 302. If the tip angle exceeds the threshold angle, method 300 continues to 310. Thus, in some embodiments, the angle of the bottle relative to a gravitational force may be determined from an accelerometer included in the sensor, wherein the sensor is configured to determine that the user behavioral action was performed if the companion motion is characterized by a tip angle that exceeds a threshold tip angle.

While force determination at 306 and angle determination at 308 are depicted as separate, asynchronous events in method 300, it will be appreciated that, in some embodiments, these determinations may occur concurrently. Alternatively, in some embodiments, the aforementioned events may occur in a different order.

At 310, method 300 includes accumulating the elapsed time at which the bottle exceeds the threshold angle. In some embodiments, a timer may be triggered when the bottle first exceeds the threshold angle. Alternatively or additionally, in some embodiments, the sensor may record a starting time stamp when the bottle first exceeds the threshold angle.

At 312, method 300 includes determining whether the tip angle does not exceed the threshold angle. Put another way, at 312, method 300 determines whether the bottle has moved to a position at which a dispensing action will not occur. If the tip angle exceeds the threshold angle, method 300 continues accumulating elapsed time at 310. If the tip angle no longer exceeds the threshold angle, time accumulation stops and method 300 continues to 314. In some embodiments, stopping time accumulation may occur by stopping a timer. Alternatively or additionally, in some embodiments, stopping time accumulation may occur by recording an ending time stamp. Further, it will be appreciated that, in some embodiments, method 300 may periodically poll the sensor to determine tip angle and/or may determine a new tip angle at any time a change in tip angle is detected by the sensor.

In some embodiments, method 300 may include, at 314, detecting a companion condition by determining whether the accumulated time lies within a predetermined time range. Thus, determining that the user behavioral action was performed may include determining if an elapsed time during which the tip angle exceeds the threshold tip angle is within a predetermined time range starting after the primary motion event is detected. The inclusion of additional companion conditions may avoid false positive detection of the user behavioral action. For example, accumulated time that is outside of the time range may be rejected as being erroneous (such as an incidental movement, a prolonged movement, such as movement during transport, a sensor error, etc.). If the accumulated time lies within the predetermined time range, method 300 continues to 316; otherwise, method 300 returns to the standby state at 302.

At 316, method 300 includes transmitting a message including behavioral data to the server computing device. In some embodiments, the message may include the elapsed time at which the bottle exceeded the tip angle threshold and/or the elapsed time at which the bottle exceeded the tip angle without exceeding the force threshold.

In some embodiments, method 300 may include, at 318, executing a delay timer before returning to the standby state at 302. This may prevent erroneous double-detection events from being recorded by the behavior reward system and/or may save power by reducing a number of transmission events from the sensor.

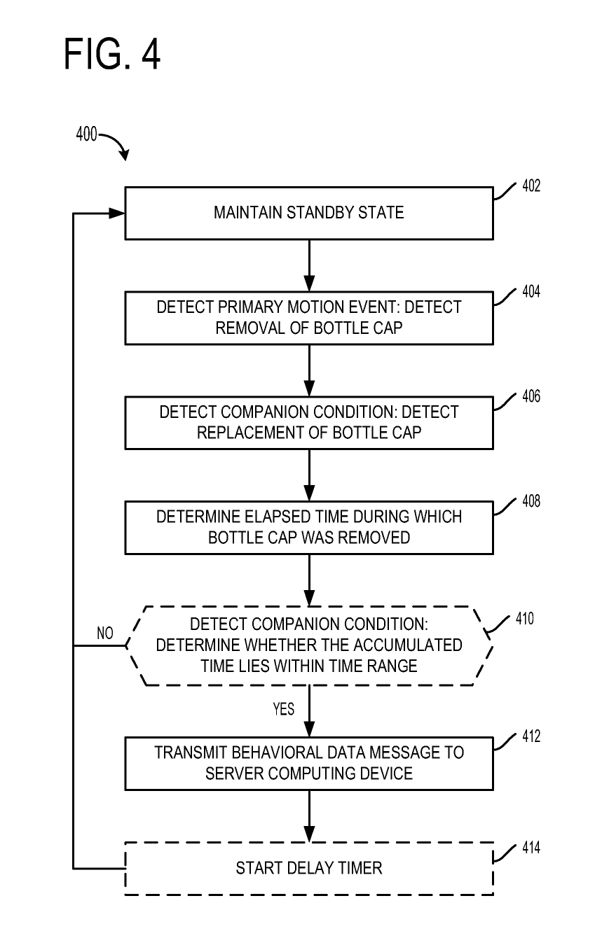

In some embodiments, a sensor included in a bottle cap for the bottle may be used in place of or to corroborate the angle- and force-based method depicted in FIG. 3. For example, FIG. 4 shows a flow chart illustrating another embodiment of a method 400 for detecting a bottle dispense action with a sensor coupled to a bottle cap. In this example, an accelerometer is included in the bottle cap sensor to determine a position of the cap relative to gravity, such as whether the cap has been turned over or placed on its side, indicating that the bottle is ready to dispense. At 402, method 400 includes maintaining a standby condition for the sensor. At 404, method 400 includes detecting a primary motion event by detecting removal of the bottle cap. For example, in some embodiments, an interrupt to a processor of the sensor may be generated when an accelerometer detects the bottle cap is removed, for example, from forces resulting from twisting and/or flipping motions. In some embodiments, a timer may be triggered when the bottle cap is removed. Alternatively or additionally, in some embodiments, the sensor may record a starting time stamp when the bottle cap is removed.

At 406, method 400 includes detecting a companion condition by detecting the replacement of the bottle cap. In some embodiments, a timer may be stopped when the bottle cap is replaced. Alternatively or additionally, in some embodiments, the sensor may record an ending time stamp when the bottle cap is replaced. Thus, in some embodiments where the sensor is configured to be operatively coupled with a bottle cap, determining that the user behavioral action was performed may include determining if the combination includes a cap removal action and a cap replacement action.

At 408, method 400 includes determining the elapsed time during which the bottle cap was removed, such as from an elapsed time value of a timer or from a difference of a starting time stamp and an ending time stamp.

In some embodiments, method 400 may include, at 410, detecting a companion condition by determining whether the accumulated time lies within a predetermined time range. For example, accumulated time that is outside of the time range may be rejected as being erroneous (such as an incidental movement, a prolonged movement, such as movement during transport, a sensor error, etc.). If the accumulated time lies within the predetermined time range, method 400 continues to 412; otherwise, method 400 returns to the standby state at 402. Thus, determining that the user behavioral action was performed may include determining if an elapsed time between the cap removal action and the cap replacement action is within a predetermined time range starting after the primary motion event is detected.

At 412, method 400 includes transmitting a message including behavioral data to the server computing device. In some embodiments, the message may include the elapsed time during which the bottle cap was removed from the bottle. In some embodiments, method 400 may include, at 414, executing a delay timer before returning to the standby state at 402. This may prevent erroneous double-detection events from being recorded by the behavior reward system and/or may save power by reducing a number of transmission events from the sensor.

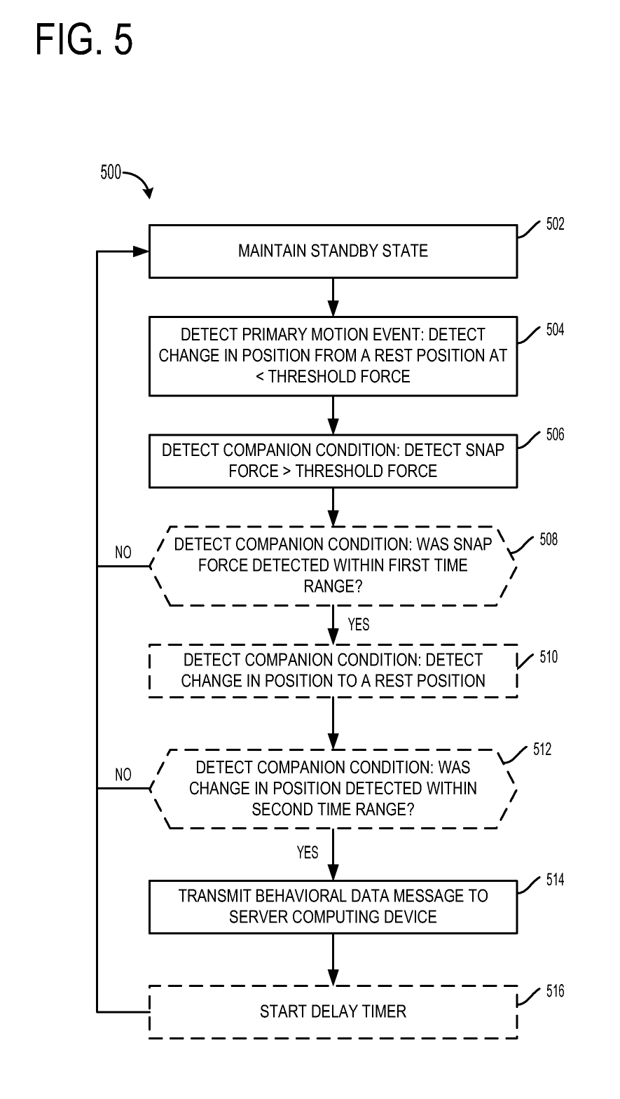

It will be understood that such sensors are not limited to the bottle dispense examples described above. For example, FIG. 5 shows a flow chart illustrating an embodiment of a method 500 for detecting a dental floss dispense action with a sensor including an accelerometer operatively coupled to a dental floss dispenser. At 502, method 500 includes maintaining a standby condition for the sensor. At 504, method 500 includes detecting a primary motion event by detecting a change in position of the dispenser, for example, a change from a resting position to a use position. Alternatively, in some embodiments, detecting the primary motion event may include detecting an angular force from an accelerometer operatively coupled with a spool of floss included in the dispenser. As explained above, in some embodiments, detection of the primary motion event may be characterized by a force that is less than a predetermined drop shock force to distinguish the primary motion event from inadvertent events, such as dropping events. In some embodiments, a timer may be triggered when the primary motion event is detected. Alternatively or additionally, in some embodiments, the sensor may record a starting time stamp when the bottle cap is removed.

At 506, method 500 includes detecting a companion condition that is characterized by a floss snapping event. A floss snapping event may include a shock force that is greater than a predetermined snap shock force associated with snapping a portion of floss from the dispenser. Thus, in some embodiments, determining that the user behavioral action was performed may include determining if the primary motion event is characterized by a force that is less than a first predetermined shock force, such as a predetermined drop shock force, and if the companion motion is characterized by a force that is greater than a second predetermined shock force, such as a predetermined snap shock force.

In some embodiments, the combination may include one or more additional companion conditions from which the determination may be judged, which may further reduce false positive determinations of the user behavioral action. For example, in the embodiment shown in FIG. 5, at 508, method 500 includes determining the elapsed time between detection of the primary motion event and detection of the companion condition, and at 510, detecting a companion condition by determining whether the accumulated time lies within a predetermined time range. For example, accumulated time that is outside of the time range may be rejected as being erroneous (such as an incidental movement, a prolonged movement, such as movement during transport, a sensor error, etc.). Thus, determining whether the user behavioral action was performed may include determining if an elapsed time between the primary motion event and the companion motion is within a predetermined time range starting after the primary motion event is detected. In the example shown in FIG. 5, if the accumulated time lies within the predetermined time range, method 500 continues to 512; otherwise, method 500 returns to the standby state at 502.

In some embodiments, determining whether the user behavioral action was performed may include determining if a second companion motion having less than the first predetermined shock force is detected by the accelerometer within a second predetermined time range starting after the first companion motion is detected. In the embodiment shown in FIG. 5, at 512, method 500 includes determining whether the change in position was detected within a second time range.

At 514, method 500 includes transmitting a message including behavioral data to the sensor computing device. In some embodiments, the message may include a time stamp indicating what time the user flossed. In some embodiments, method 500 may include, at 516, executing a delay timer before returning to the standby state at 502. This may prevent erroneous double-detection events from being recorded by the behavior reward system and/or may save power by reducing a number of transmission events from the sensor.

As explained above, in some embodiments, detection of a companion condition may include detection of an event within a predetermined time window. However, for some user behavioral actions where activity is sustained over time, prolonging power source lifetime may be difficult in such uses where the active state is repeatedly triggered, detector information is read, and messages are transmitted. Non-limiting examples of such activities that might be detected with the accelerometers described above include walking, jogging, gardening, housekeeping, and so on, though it will be appreciated that other activities may be detected with suitable detectors. For example, an acoustic sensor may be used to monitor time spent practicing a musical instrument.

In such cases, a companion condition may be that a particular activity is sustained (within an acceptable tolerance) for a predetermined time interval. In such embodiments, the sensor may only track the incidence of interrupts generated in response to, for example, motion events. If the activity stops before the prescribed time, the sensor does not send a message; if the activity continues for the prescribed time and it is determined that the user behavioral action was performed, in some embodiments, the sensor may send a single message reporting that the user behavioral action was performed. Alternatively, in some embodiments, the sensor may periodically transmit a count of the interrupts detected at predetermined time intervals, so that the server computing device may make the determination of whether the companion condition is satisfied. Thus, the sensor may remain in the standby state for a comparatively longer time than if the sensor were to read the data, make a determination, and send a message periodically while the user behavioral action is being performed. By prolonging the time during which the sensor is in the lower power standby state, the lifetime of the power source may be extended.

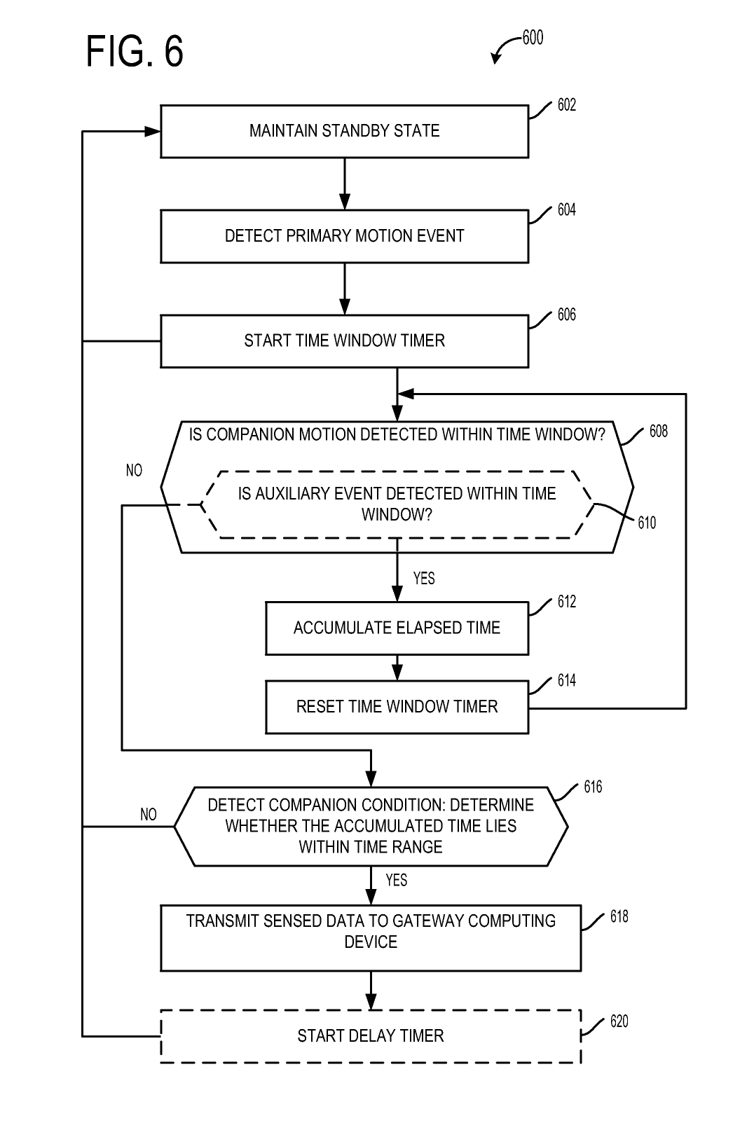

FIG. 6 shows a flow chart illustrating an embodiment of a method 600 of detecting sustained (within an acceptable tolerance) movements using an accelerometer included in a sensor, such as in a pedometer. As shown in FIG. 6, method 600 is performed at the sensor. However, it will be appreciated that portions of method 600 (such as detection of the companion condition) may be performed at the server computing device. At 602, method 600 includes maintaining a standby condition for the sensor. At 604, method 600 includes detecting a primary motion event, such as a detected step. In some embodiments, detection of the primary event 604 may include determining that a detected event satisfies a configurable threshold condition. For example, in a pedometer scenario, detecting the primary event 604 may include detecting, at an accelerometer, a force that exceeds a configurable threshold force.

At 606, method 600 includes starting a time window timer. The time window timer counts down (or up) to a predetermined time window value. The size of the time window value may be configured according to the activity, and may reflect a tolerance for inactivity. For example, in the pedometer example described here, the time window value may be set at 10 seconds, so that a step taken within 10 seconds of a previous step will count as a sustained activity, potentially giving a user an opportunity to wait for a traffic signal without the inactivity being counted as a break in the activity. However, it will be appreciated that any suitable time window value may be employed without departing from the scope of the present disclosure. As will be described below, subsequently detected motion occurring within the time window causes method 600 to accumulate the time elapsed since the last detected motion and reset the time window timer. Thus, activity that results in sustained or intermittent motion, the recurrence of which is within the time window, causes method 600 to continue accumulating time.

At 608, method 600 includes determining whether motion is detected within the time window. If motion is detected within the time window, method 600 continues to 612, where method 600 comprises accumulating the elapsed time. For example, in some embodiments, method 600 may add the elapsed time between subsequently detected movements to an accumulator. At 614, method 600 includes resetting the time window timer and returning to 608.

In some embodiments, 608 may include, at 610, determining if an auxiliary event condition was detected within the time window. Auxiliary events may be detected by other detectors included in the sensor. For example, in a scenario used to track time spent practicing a musical instrument, an auxiliary event may be detected by an acoustic sensor (such as a microphone or a vibration sensor) for measuring whether the instrument is actually being played. Further, in such embodiments, the acoustic sensor may be configured to determine how well the user is performing based on a comparison of detected frequencies and musical scale frequencies, including sharps, flats, and whole notes. Thus, it may be possible to determine whether the user is making earnest efforts to practice the instrument. In a scenario where time spent reading is tracked, the auxiliary event may be detected by a photosensor used to detect changing light patterns that may result from a user's actions while reading the book.

If motion is not detected within the time window, method 600 continues to 616, detecting the companion condition by determining whether the accumulated time lies within a predetermined time range. For example, accumulated time that is outside of the time range may be rejected as being erroneous (such as an incidental movement, prolonged movement, such as movement during transport, a sensor error, etc.) or as not qualifying for a rewardable user behavioral action (e.g., not jogging for a prescribed time). If the accumulated time lies within the predetermined time range, method 600 continues to 618, transmitting a message including behavioral data to the server computing device. In some embodiments, the message may include the elapsed time during which the activity was detected and/or a count of a number of interrupts generated.

If the companion condition is not detected, method 600 returns to the standby state at 602 without sending a message. Additionally or alternatively, in some embodiments, method 600 may include, at 620, executing a delay timer before returning to the standby state at 602. This may prevent erroneous double-detection events from being recorded by the behavior reward system and/or may save power by reducing a number of transmission events from the sensor.

While the above-described examples are related to sensors that determine whether the user behavioral action was performed, it will be understood that, in some embodiments, the determination may be performed in part or in whole at the server computing device. For example, in some embodiments, a companion condition may be determined from other aspects of the behavior reward system. In one example, location information derived from media access control (MAC) addresses for various gateway computing devices receiving messages from a sensor affixed to a user's bicycle may be used to determine that a user commuted by bicycle.

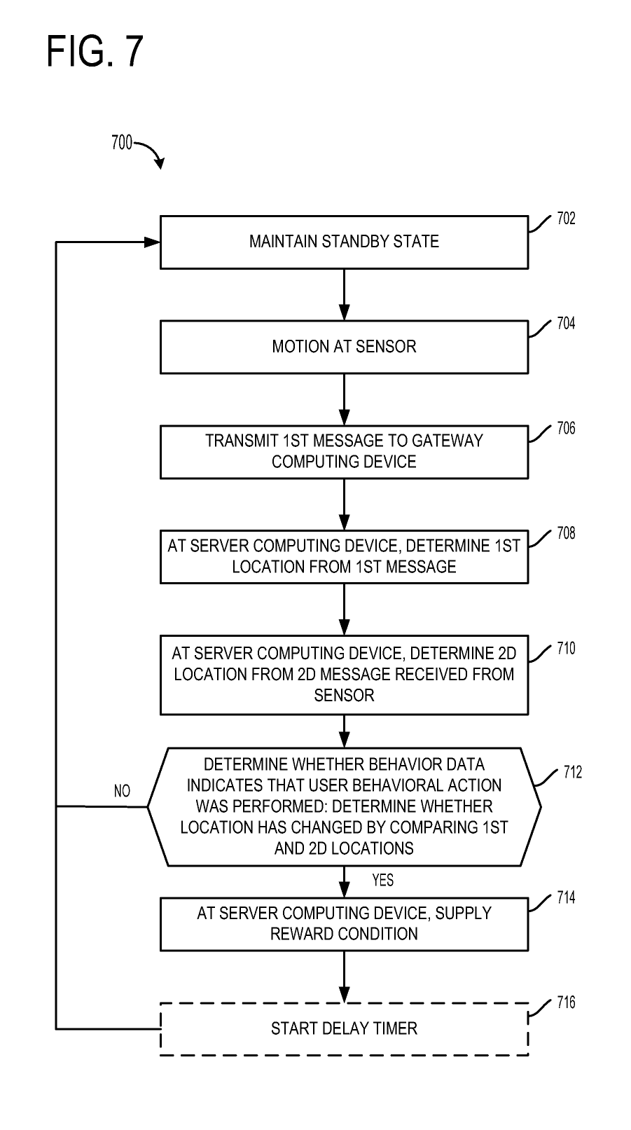

For example, FIG. 7 shows a flow chart illustrating an embodiment of a method 700 for detecting a reward condition from detected motion and location information. The example depicted in FIG. 7 describes a method of tracking instances of a user commuting by bike. In the example shown in FIG. 7, a sensor including an accelerometer is coupled to a user's bicycle. Method 700 includes, at 702, maintaining a standby condition for the sensor. At 704, method 700 includes detecting motion at the sensor. For example, in some embodiments, an interrupt to a processor of the sensor is generated when the bicycle is moved. At 706, method 700 includes transmitting a first message from the sensor to a first gateway computing device.

At 708, method 700 includes determining a first location for the sensor from the first message received from the sensor. For example, the first location may be determined by the server computing device from the MAC address of the first gateway computing device from which the first message was transmitted.

At 710, method 700 includes determining a second location for the sensor from a second message received from the sensor, and, at 712, determining whether the sensor has changed locations by comparing the first and second locations. For example, when the user arrives at work, the bicycle may send a second message to a second gateway computing device having a different MAC address. Thus, the server computing device may be able to determine the new location for the sensor.

If the sensor has changed locations, method 700 continues to 714. At 714, method 700 includes registering a reward condition at the server computing device. If the lunch sack has not changed locations, method 700 skips to the standby state at 702.

In some embodiments, method 700 may include, at 716, starting a delay timer. This may prevent erroneous double-detection events from being recorded by the behavior reward system and/or may save power by reducing a number of transmission events from the sensor.

In some embodiments, the behavior reward system may be configured to distinguish between users interacting with a sensor so that the reward is offered to a particular user who performed a particular user behavioral action. In some embodiments, the sensor may include a radio frequency identification (RFID) reader configured to read an RFID tag included in a user tag possessed by a particular user, so that user identification information included in the RFID tag is read when the user tag is within radio proximity of the RFID reader. However, powering an RFID reader, even temporarily, may consume an undesirable amount of power and shorten the lifetime of the sensor's power source.

Accordingly, in some embodiments, both the user tag and the sensor may include magnetically-activated switches (such as magnetic reed switches and Hall effect switches) configured to cause a user identification message to be sent to the server computing device so that the user identification message is used to correlate behavior data received from the wireless sensor with the identity of a particular user performing the user behavioral action.

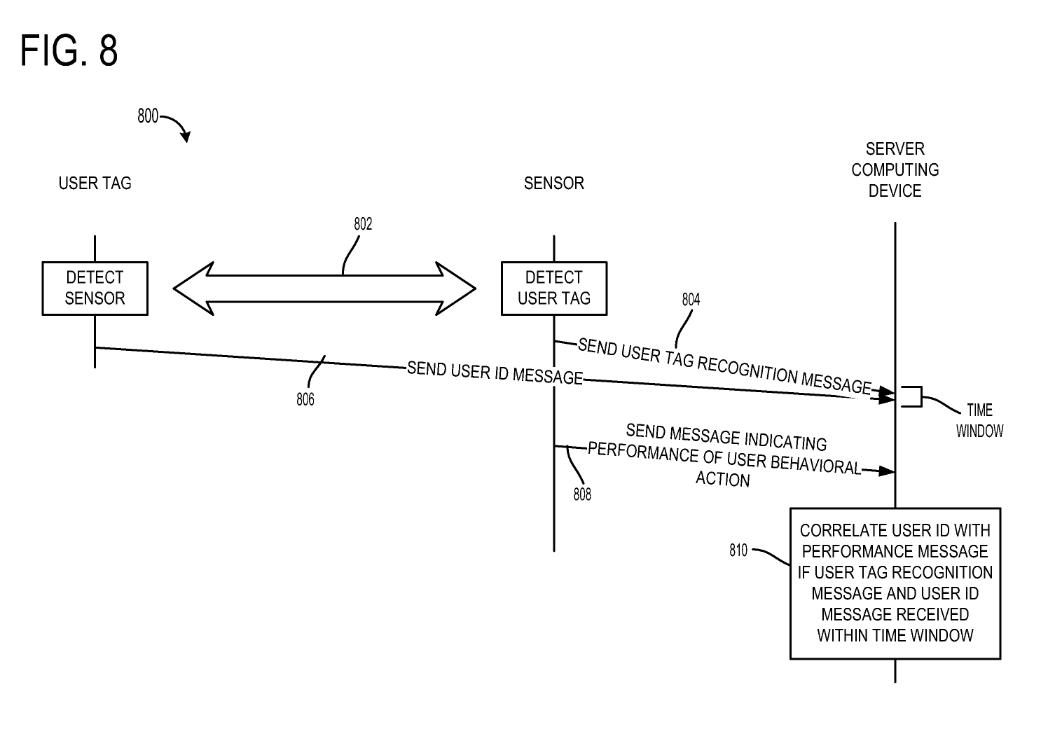

FIG. 8 shows a flow chart illustrating an embodiment of a method 800 of correlating a user identity with a user behavioral action detected by a sensor. At 802, method 800 includes, at the user tag, detecting the sensor, and, at the sensor, detecting the user tag. In some embodiments, a magnetically-activated switch included in the user tag detects a magnet included in the sensor, and a magnetically-activated switch included in the sensor detects a magnet included in the user tag.

At 804, method 800 includes sending a user tag recognition message from the sensor to the server computing device. The user tag recognition message may include any suitable information. In the embodiment shown in FIG. 8 the user tag recognition message includes a sensor identifier. At 806, method 800 includes sending a user identification message from the user tag to the server computing device. The user identification message may include any suitable information. In the embodiment shown in FIG. 8, the user identification message includes a user identifier associated with the particular user bearing the user tag. At 808, method 800 includes sending a message indicating the performance of the user behavioral action from the sensor to the server computing device. In the embodiment shown in FIG. 8, the performance message is configured to include the sensor identifier.

At 810, method 800 includes correlating the user identity with the performance message if the user identification message and the user tag recognition message were received within a predetermined time window. Because the user tag recognition message and the user identification message may be generated concurrently (within an acceptable tolerance), the messages may be received by the server computing device within a predetermined time window of one another. Thus, receipt of such messages within the time window indicates that a particular user identification message should be correlated with a respective user tag recognition message. Additionally or alternatively, in some embodiments, time stamps included in the user identification message and the user tag recognition message may be compared by the server computing device to determine if the messages were transmitted within the predetermined time window.

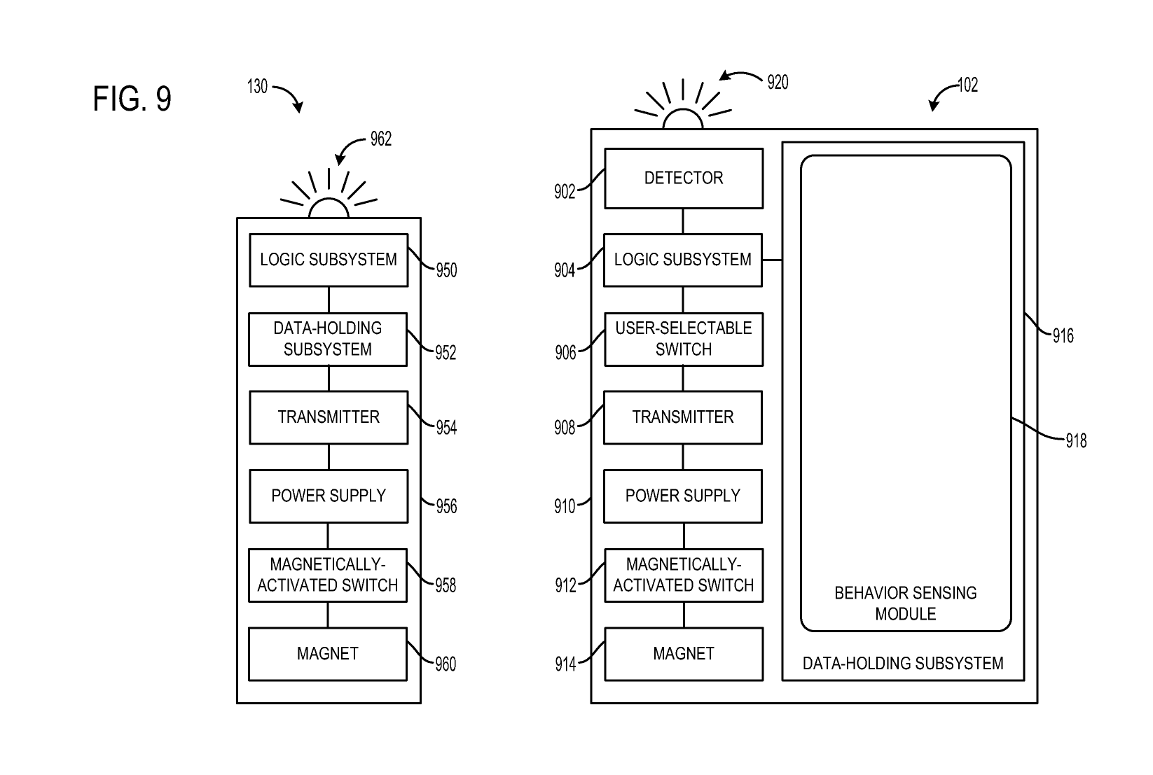

FIG. 9 schematically shows embodiments of a user tag 130 and a sensor 102. As shown in FIG. 9, sensor 102 is a computing device comprising a data-holding subsystem 916 and a logic subsystem 904. The example sensor 102 shown in FIG. 9 also includes an on-board power supply 910 and a wireless transmitter 908. Power supply 910 may be any suitable local power supply, such as a battery, an energy-harvesting device, or a photovoltaic power supply. Wireless transmitter 908 includes a wireless transmitter configured to wirelessly communicate with the server computing device over one or more of a local wireless network, a cellphone network, or a wireless Internet connection. Wireless transmitter 908 is configured to transmit messages only when sensor 102 is in an active state. Accordingly, in some embodiments, wireless transmitter 908 may be powered down when sensor 102 is in a standby state. Sensor 102 may also include a clock (not shown) configured to synchronize messages transmitted by wireless transmitter 908.

The embodiment of sensor 102 shown in FIG. 9 includes a detector 902 for detecting an event and sending signals to behavior sensing module 918. Non-limiting examples of detectors 902 include accelerometers, photosensors, acoustic sensors, pressure sensors, thermal sensors, and contact sensors. In some embodiments, sensor 102 may include a plurality of detectors 902 of any suitable type.

Detector 902 is configured to generate an interrupt at the initiation of a detectable event. For example, in an embodiment including an accelerometer, the accelerometer may be configured to generate an interrupt upon detecting the initiation of a motion event. Detector 902 may be configured to collect data at different rates according to whether sensor 102 is in a standby state or in an active state. For example, an accelerometer may be configured to sample motion data at a first rate (for example, 1 Hz) in the standby state and to sample motion data at a second rate (for example, 4 Hz) in the active state, the second rate being greater than the first rate. Further, it will be understood that suitable pulse width modulation schemes may be employed to interpolate between samples. Configuring detector 102 to collect data at variable rates may conserve power use in sensor 102.

Behavior sensing module 918 is configured to receive signals, including interrupts and detector information, from detector 902 and to generate messages for transmission to a server computing device via wireless transmitter 908. Behavior sensing module 918 may only send such messages if it is determined that the user has performed the user behavioral action. Such messages may include behavioral data, including detector information generated by detector 902 (e.g., force data collected by an accelerometer, temperature data collected by a thermal sensor, etc.). Additionally, in some embodiments, the behavioral data may include metadata, such as sensor identifiers, user identifiers and/or timestamps. Such messages may have any suitable size and format. One non-limiting example message includes 32 bits of content (e.g., behavioral data and metadata) and a 10-bit header having a 6-bit address and a 4-bit sequence device type. It will be understood that suitable error-checking schemes may be employed with such messages.

Such messages may be transmitted upon generation and/or may be stored in data-holding subsystem 916 for transmission at a later time. For example, data-holding subsystem 916 may include a buffer configured to store a predetermined number of messages, so that, upon generation of a new message, sensor 102 transmits all of the stored messages along with the new message. Upon receipt of the plurality of messages, the server computing device may check the incoming messages against previously received messages; buffering and retransmitting messages in this way may identify and/or correct errors introduced by missing or garbled messages.

In some embodiments, sensor 102 may include a user-selectable switch 906 configured to cause sensor 102 to transmit messages in response to a user input at user-selectable switch 906. For example, a user may press a button included in sensor 102 to cause one or more messages to be transmitted. This may conserve power, permitting the user to prompt a transmission event when the user is within transmission range of a gateway computing device or a server computing device. In some embodiments, sensor 102 may be configured to store the messages until a user input is received at user-selectable switch 906. This may also conserve power by preventing transmission events when sensor 102 is outside of the transmission range.

As shown in the embodiment of sensor 102 depicted in FIG. 9, sensor 102 may include an indicator 920 configured to alert the user of activity at sensor 102. For example, indicator 920 may alert the user that the user behavioral action has been detected, that a message has been sent, or that the power supply is low. While indicator 920 is depicted as an indicator lamp, such as an LED, it will be appreciated that any suitable indicator or combination of indicators may be employed without departing from the scope of the present disclosure. Other non-limiting examples of indictor 920 include audible indicators, such as speakers, and haptic indicators, such as vibrators.

As explained above, in some embodiments, sensor 102 may be configured to interact with user tag 130 so that a particular user may be associated with a detected user behavioral action. FIG. 9 schematically shows an embodiment of user tag 130, including a logic subsystem 950, a data-holding subsystem 952, a wireless transmitter 954, a power supply 956, and an indicator 962, each of which may be similar to the analogous components described above with respect to sensor 102, though one or more may be configured differently.

The embodiment of user tag 130 depicted in FIG. 9 also includes a magnetically-activated switch 958 and a magnet 960. Magnetically-activated switch 958 of user tag 130 is configured to detect a magnetic field of magnet 914 of sensor 102. Likewise, magnetically-activated switch 912 of sensor 102 is configured to detect a magnetic field of magnet 960 of user tag 130. Magnetically-activated switches 912 and 958 may include suitable magnetic reed switches and Hall-effect switches configured to cause a user identification and user tag recognition messages to be sent to the server computing device so that behavior data received from the sensor 102 may be correlated with user identification information received from user tag 130, and thus correlate with the identity of a particular user with a particular user behavioral action. In some embodiments, user tag 130 and/or sensor 102 may be configured to provide suitable indications that the detect events have occurred via indicator(s) 920 and/or 962, signaling the user that user tag 130 and sensor 102 have recognized one another.

In some embodiments, sensor 102 may include a radio frequency identification device (RFID) reader (not shown). The RFID reader may read an RFID tag (not shown) included in user tag 130 so that sensor 102 may read and transmit user identification information encoded in the RFID tag with a detected user behavioral action so that the server computing device may attribute the user behavioral action to the user.

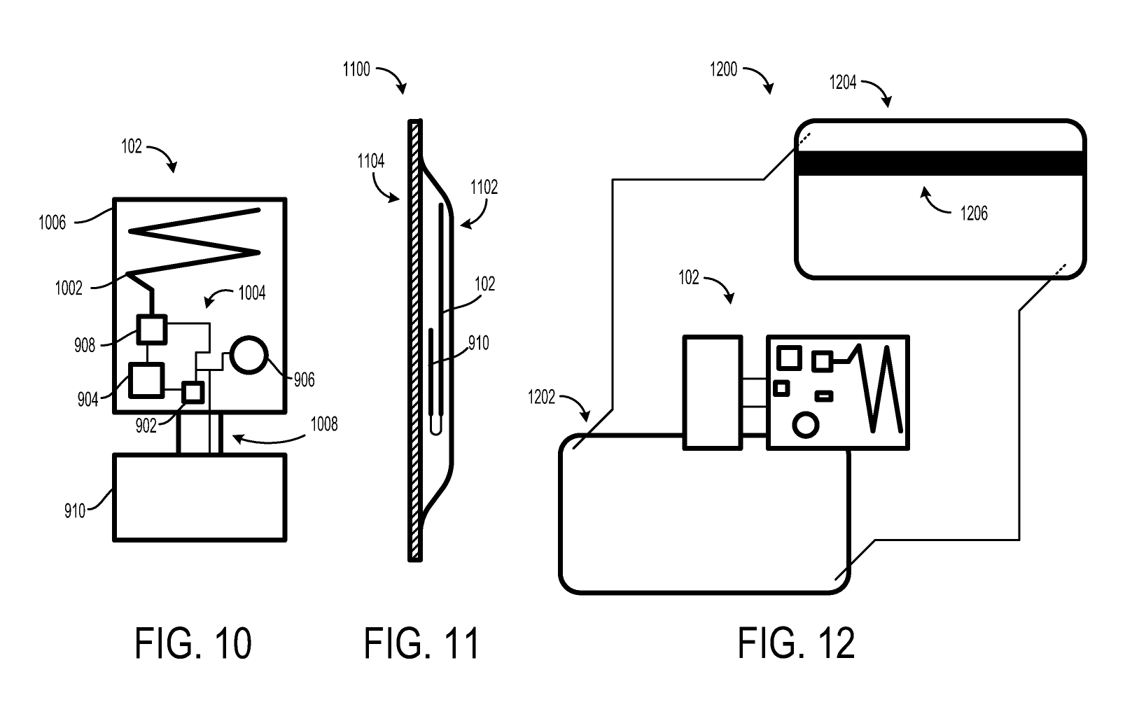

Sensor 102 may be fabricated in any suitable way. For example, FIG. 10 schematically shows an embodiment of sensor 102 fabricated by a photolithographic technique on a flexible substrate 1006, such as a polyimide substrate. Flexible substrate 1006 is configured to support the various components of sensor 102, including antenna 1002, wireless transmitter 908, logic subsystem 904, detector 902, power supply 910, and user-selectable switch 906. The various components of sensor 102 may be interconnected by suitable flexible interconnects 1004 (shown in thin lines) such as flexible copper interconnects. In the embodiment shown in FIG. 10, power supply 910 is configured as a flexible lithium battery connected via flexible leads 1008 to flexible substrate 1006, so that power supply 910 may be folded against flexible substrate 1006 during packaging.

Sensor 102 may be packaged for use in any suitable way. For example, FIG. 11 depicts an example embodiment of sticker 1100 including sensor 102 packaged in a sealed flexible housing 1102 and including an adhesive layer 1104 disposed on an exterior surface of flexible housing 1102. Adhesive layer 1104 is configured to bond flexible housing 1102 to an object with which a user interacts when performing the user behavioral action. For example, sticker 1100 may be a “puffy” style sticker, having a raised bubble housing encapsulating sensor 102 and having an adhesive on one surface. One non-limiting example of sticker 1100 has dimensions of approximately 40 mm high×2 mm deep×28 mm wide. In some examples, sticker 1100 may have shapes and colors configured to make them appealing to the user. In some non-limiting examples, a sensor sticker configured to be attached to a child's toothpaste tube may be shaped and colored so that the sensor sticker resembles a giraffe, an alligator, or a bunny.

It will be appreciated that sensor 102 is not limited to the sticker packaging described with respect to FIG. 11. For example, FIG. 12 shows an exploded view of an embodiment of a credit-card style device 1200 including sensor 102. As shown in FIG. 12, sensor 102 may be hermetically sealed between layers 1202 and 1204 that define credit-card style device 1200, which may be convenient for a user in pedometer style applications. In some embodiments, information about the user may be stored on magnetic stripe 1206.

Further, while some of the sensors described herein are standalone sensors, in some embodiments, sensor 102 may be integrated into another device (e.g., a home temperature control station, an automobile electronic control system, a toothbrush, a dental floss dispenser, a medicine, vitamin, or drink bottle, a toy, etc.).

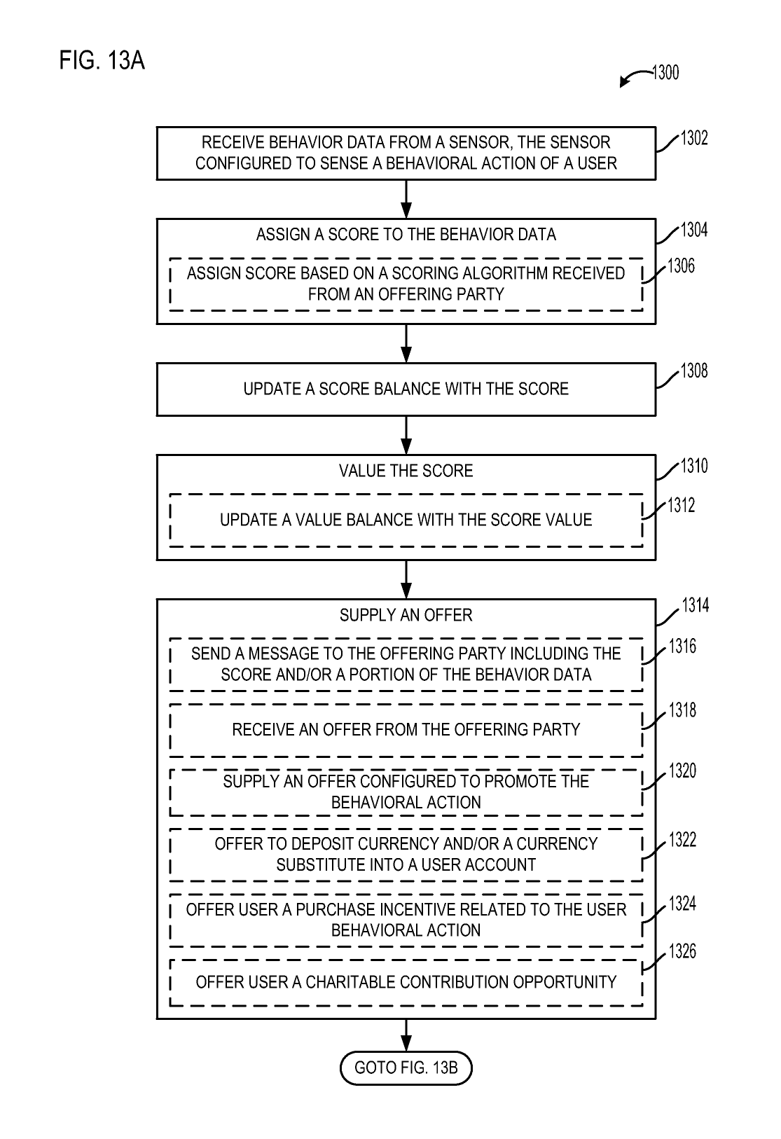

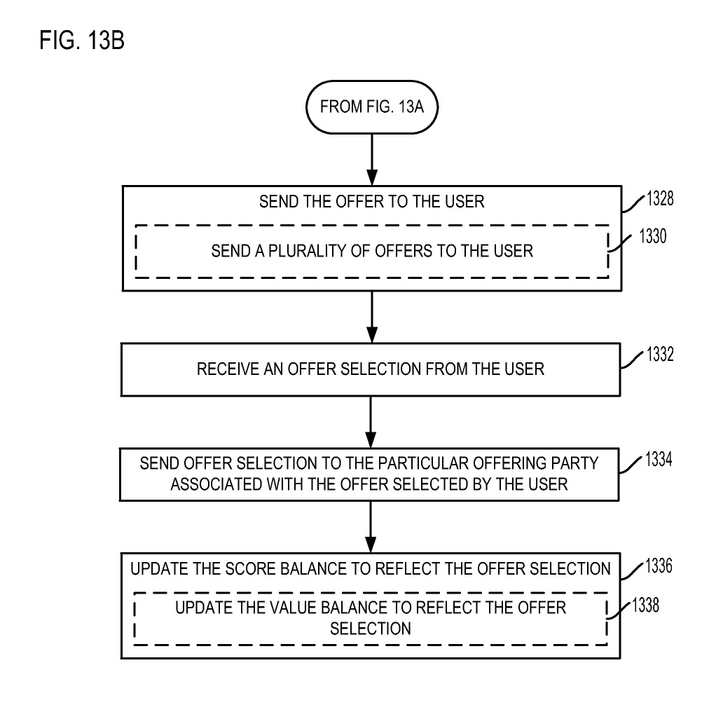

As explained above, once a user behavioral action is detected by the sensor, the server computing device makes an offer available to a user. FIGS. 13A and 13B illustrate a flow chart for an embodiment of a method 1300 for positively reinforcing a user behavior. Method 1300 may be performed by any suitable hardware, such as the hardware described and shown herein.

Method 1300 comprises, at 1302, receiving behavior data from a sensor, the sensor configured to sense a behavioral action of a user. At 1304, method 1300 comprises assigning a score to the behavior data. Using the score, the behavior reward system and/or the offering party may adapt the offer to the detected behavior. For example, some behavioral actions may score higher than some other behavioral actions and may be rewarded with a comparatively more attractive offer. The score may be assigned in any suitable way. In some embodiments, the score may be assigned according to a user-configurable algorithm. For example, the user may configure the score to be proportional to a duration of the behavioral action.

In some embodiments, assigning the score 1304 may comprise, at 1306, assigning the score based on a scoring algorithm received from an offering party. In one scenario, the offering party may provide a formula used by the behavior reward system to translate the detected behavioral action into a score. For example, in a scenario where bicycle commuting is the behavior being detected and scored, a scoring algorithm may generate a score based on a number of miles that the user commutes by bicycle, based on an amount of fuel that the user saves as a result of not driving, and/or based on a duration for which the user's heart rate exceeded a predetermined threshold during the commute.

At 1308, method 1300 comprises updating a score balance with the score. Thus, the behavior reward system may accumulate and track scores from the user's behavioral activities. This may provide a convenient way for the user to keep track of the user's progress without manually logging the user's progress.

At 1310, method 1300 comprises valuing the score. In some embodiments, valuing the score may include assigning a monetary value to the score. In some embodiments, the score may be valued arbitrarily. For example, instances of brushing and flossing teeth may be assigned a preconfigured monetary value. Alternatively, in some embodiments, the score may be valued in relation to a value of the behavior detected. For example, the score for commuting by bicycle may be assigned a value corresponding to fuel savings.

In some embodiments, valuing the score 1310 may comprise, at 1312, updating a value balance with the score value. Thus, a user may, over time, accumulate value in an account based on the user's performance of the behavioral action. This may incentivize the user to continue performing the behavioral action, potentially decreasing a chance that the user may fall back into old habits.

At 1314, method 1300 comprises supplying an offer to be sent to the user. The offer is provided by an offering party responsive to the detected behavioral action. As explained above, the offer may be any suitable offer related to rewarding and incentivizing the sensed behavioral action, including offers of goods or services, monetary incentives and/or monetary discounts, sale promotions, and/or competition incentives and prizes. Some non-limiting examples of suitable offers are described below.

In some embodiments, the offer may be generated by the offering party. In such embodiments, supplying the offer at 1314 may comprise, at 1316, sending a message to the offering party. The message may include one or more of the score, the score balance, and a portion of the behavior data, or any other suitable content (e.g., a user identifier, a time stamp, a date stamp, etc.) that the offering party may use when generating the offer. In such embodiments, supplying the offer 1314 further comprises, at 1318, receiving the offer from the offering party. Additionally or alternatively, in some embodiments, the offer may be generated at the server computing device according to algorithms or conditions provided by the offering party.

In some embodiments, the offer may be suitably related to the behavioral action detected by the sensors. For example, in some embodiments, supplying the offer 1314 may comprise, at 1320, supplying an offer configured to promote the behavioral action. Thus, in one scenario, a detected bicycle trip by the user may lead a bicycle retailer to offer free or discounted bicycle maintenance or bicycle supplies if the user commutes a predetermined distance by bicycle. In another scenario, a bicycle enthusiast organization may offer the user an opportunity to participate in organized bicycle riding activities or to have the user's bicycle-riding activity logged and displayed on a leaderboard as a way of encouraging future bicycle activity in the user and/or in others. In a scenario where the sensed behavioral action is an oral hygiene activity (e.g., flossing, brushing, etc.), the user's dentist may provide a discounted future office visit if the user flosses and brushes two or more times per day.

While the offers described above may also be related to sales promotion, it will be understood that any suitable offer configured to promote the behavioral action may be employed without departing from the scope of the present disclosure. For example, the offering party may offer an interactive avatar, a special ringtone, membership in an organization or an online interactive community to the user.

In some embodiments, supplying an offer at 1314 may comprise, at 1322, offering to deposit currency and/or a currency substitute into a user behavior reward account. In some embodiments, an offering party may offer to deposit money into a user's personal account, such as a checking account, a retirement account, or an equity account in response to a detected behavioral activity. For example, the employer may elect to share a reduction in the user's health insurance premiums related to the user's healthy lifestyle and/or to share a reduction in parking and/or transit costs realized by the user's commuting choice as an approach to incentivizing the user's bicycle-riding behavior. In this example, the user's employer may offer to deposit money into a user's account in response to commuting a predetermined distance by bicycle. While this scenario relates to a cash-based incentive, it will be appreciated that suitable credit-based incentives may be employed as well. For example, the offering party may offer a gift card or other stored value card to the user in response to the user's behavioral action, may offer to make a contribution to a user's frequent-flier mileage account in response to the user's behavioral action, or the like.

In some embodiments, supplying the offer may comprise, at 1324, offering a purchase incentive related to the user behavioral action. For example, the offer may be a sales promotion generated in response to the user behavioral action. As described above, a bicycle retailer may offer a discount on bicycle-related goods or services in response to the user behavioral action. A consumer products manufacturer may offer the user a discount on toothpaste as the user's current tube is emptied, or may offer the user a free trial supply of a new oral hygiene product related to the behavioral activity. Thus, suitable purchase incentives may include coupons, reduced cost samples, and rebates or other suitable reward tokens.

In some embodiments, supplying the offer 1314 may comprise, at 1326, offering the user an opportunity to make a charitable contribution. The charitable contribution may be made in any suitable way. For example, in some embodiments, the offering party may be a charity, while, in some other embodiments, the offering party may offer the user the opportunity to make a contribution to a separate charitable entity. Further, in some embodiments, the offering party may offer the user the opportunity to make a contribution on the offering party's behalf. For example, in a scenario where the offering party is the user's employer, the employer may offer the user the opportunity to select a charity to receive a donation from the employer in response to the user's performance of a behavioral action.

Turning to FIG. 13B, method 1300 comprises, at 1328, sending the offer to the user, the offer being configured to be displayed on a client computing device. As explained above, the user may access a user interface displayed on a client computing device, such as a mobile phone, laptop, or kiosk. Offers supplied to the user are displayed via the user interface for the user's consideration. Thus, the user may access and interact with the user's behavior reward account and/or stored value card via the user interface displayed on the client computing device. This may provide the user an opportunity to easily track the user's behavioral activities, select offers the user is interested in accepting, and realize the benefits of the offers the user has accepted via a convenient behavior reward system interface. In some embodiments, sending the offer to the user 1328 may comprise, at 1330, sending a plurality of offers to the user, the offers being provided by one or more offering parties. Thus, the user may choose to accept one or more offers from one or more offering parties.

At 1332, method 1300 comprises receiving an offer selection from the user, and, at 1334, sending the offer selection to the particular offering party associated with the offer selected by the user. Thus, in one example, a user's selection of a coupon offer from a manufacturer and a free music download offer from a retailer may be conveniently managed by the user from the user interface, and centrally administered by the server computing device. This may allow the user to avoid unpleasant experiences where the user is bombarded by separate emails and popups from several sources.

In some embodiments, centrally administering the offers and the offer selections may provide a basis for developing a user profile reflecting the user's interests. If the user elects to share the user profile with offering parties, the offering party may be able to customize offers to the user's interests.

As explained above, in some embodiments, a user may accumulate a score and/or a score value balance over time based on the user's detected behavioral actions, so that the user behavioral action may be tracked by the user, and so that the user may be encouraged to continue a particular behavioral action in the future. In some of those embodiments, the user's account may act as an exchange where accumulated scores and/or score value may be traded for reward opportunities. Thus, in some embodiments, the offering party may provide the user with an offer responsive to the user behavioral action and exchange for some of the user's accumulated score and/or score value. For example, an offering party may provide the user with an offer for credit at an e-commerce platform or online retailer (which may be the offering party's own platform, or may be a platform for a different party) in exchange for a portion of the user's accumulated reward points or reward earnings. In such embodiments, the user's account may be updated responsive to the user's selection of an offer. Thus, in some embodiments, method 1300 may comprise, at 1336, updating the score balance to reflect the offer selection, and/or, at 1338, updating the value balance to reflect the offer selection. For example, in some embodiments, an offer price associated with the offer selection may be deducted from the value balance.

As explained above, the various computing devices described herein include suitable logic and data-holding subsystems. In some embodiments, the computing devices may also include suitable computer readable media and display subsystems.

Suitable logic subsystems may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

The data-holding subsystem may include one or more physical, non-transitory, devices configured to hold data and/or instructions executable by the logic subsystem to implement the herein described methods and processes. When such methods and processes are implemented, the state of the data-holding subsystem may be transformed (e.g., to hold different data).

The data-holding subsystem may include removable computer-readable media and/or built-in devices. The data-holding subsystem may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Removable computer-readable media may include CDs, DVDs, HD-DVDs, Blu-Ray Discs, EEPROMS, and/or floppy disks, among others.

The data-holding subsystem may include devices with one or more of the following characteristics: volatile, nonvolatile, dynamic, static, read/write, read-only, random access, sequential access, location addressable, file addressable, and content addressable. In some embodiments, the logic subsystem and the data-holding subsystem may be integrated into one or more common devices, such as an application specific integrated circuit or a system on a chip.

It will be understood that the data-holding subsystems described herein include one or more physical, non-transitory devices. In contrast, in some embodiments, aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The term “module” may be used to describe an aspect of the various computing devices disclosed herein that is implemented to perform one or more particular functions. In some embodiments, such a module may be instantiated via the logic subsystem executing instructions held by the data-holding subsystem. It will be understood that different modules may be instantiated from the same application, service, code, application programming interface, etc. The same module may be instantiated by different applications, services, codes, application programming interfaces, etc. The term module is meant to include individual or groups of executable files, data files, libraries, drivers, scripts, database records, etc.

When included, the display subsystem may be used to present a visual representation of data held by the data-holding subsystem. As the methods and processes described herein change the data held by the data-holding subsystem, the state of the display subsystem may be transformed to represent the changes in the underlying data visually. The display subsystem may include one or more display devices utilizing virtually any type of technology. Such display devices may be combined with the logic subsystem and/or the data-holding subsystem in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A wireless sensor configured to detect a user behavioral action, comprising:
a power source;
an accelerometer;
a transmitter; and
a data-holding subsystem configured to hold instructions executable by a logic subsystem to:
cause the wireless sensor to transition from a standby state to an active state in response to the accelerometer detecting initiation of a motion event,
while the wireless sensor is in the active state, determine whether accelerometer information received from the accelerometer indicates that the motion event is the user behavioral action, and
if the motion event is determined to be the user behavioral action, cause the transmitter to transmit behavior data associated with the user behavioral action.

2. The wireless sensor of claim 1, wherein the standby state corresponds to a lower power state than the active state.

3. The wireless sensor of claim 2, wherein the accelerometer is configured to sample motion data at a first rate in the standby state, and wherein the accelerometer is configured to sample motion data at a second rate in the active state, the second rate being greater than the first rate.

4. The wireless sensor of claim 2, wherein the wireless sensor is configured to re-enter the standby state if another motion event is not detected within a predetermined time interval.

5. The wireless sensor of claim 1, wherein the accelerometer produces an interrupt in response to detecting initiation of the motion event.

6. The wireless sensor of claim 1, wherein the data-holding subsystem is configured to store behavior data for a plurality of user behavioral actions for transmission in a single message.

7. The wireless sensor of claim 1, further comprising a user-selectable control configured to cause the wireless sensor to transmit the behavior data responsive to user input received at the user-selectable control.

8. The wireless sensor of claim 1, wherein the power source includes a flexible lithium battery and is operatively coupled with a flexible substrate, the flexible substrate configured to support the accelerometer.

9. The wireless sensor of claim 8, wherein the flexible substrate is packaged in a flexible housing, wherein an exterior surface of the flexible housing includes an adhesive layer configured to bond the flexible housing to an object with which a user interacts when performing the user behavioral action.

10. A behavior reward system configured to positively reinforce user behavior based on a user behavioral action performed by a user, the behavior reward system comprising:
a wireless sensor configured to transmit behavior data generated in response to an interrupt generated by an accelerometer included in the wireless sensor; and
a server computing device including a data-holding subsystem configured to hold instructions executable by a logic subsystem to:
determine whether the behavior data indicates that the user behavioral action was performed; and
if the behavior data indicates that the user behavioral action was performed, supply a reward offer to the user.

11. The behavior reward system of claim 10, wherein the behavior data includes a count of a number of interrupts generated by the accelerometer.

12. The behavior reward system of claim 10, wherein the behavior data includes force data generated by the accelerometer.

13. The behavior reward system of claim 10, further comprising a user tag associated with a particular user, the user tag being configured to interact with the wireless sensor so as to cause a user identification message to be sent to the server computing device, the instructions being further executable to use the user identification message to correlate behavior data received from the wireless sensor with the particular user.

14. The behavior reward system of claim 13, wherein the user tag includes a transmitter and a magnetically-activated switch, the magnetically-activated switch configured to cause the transmitter to send the user identification message in response to an interaction with a magnet included in the wireless sensor.

15. At a wireless sensor configured to be operatively coupled with an object with which a user interacts when performing a user behavioral action, a method of detecting the user behavioral action, the method comprising:
detecting a primary event;
detecting a companion condition;
determining whether a combination of the primary event and the companion condition indicates that the user behavioral action was performed; and
if the combination indicates that the user behavioral action was performed:
generating behavior data from the primary event as detected and the companion condition as detected, and
transmitting the behavior data to a server computing device.

16. The method of claim 15, wherein the primary event includes a primary motion event detected by an accelerometer included in the wireless sensor.

17. The method of claim 16, wherein said determining includes determining that the user behavioral action was performed if the primary motion event is characterized by less than a predetermined drop shock force.

18. The method of claim 16, wherein the companion condition includes a companion motion detected by the accelerometer, and wherein generating the behavior data includes generating behavior data from accelerometer information provided by the accelerometer.

19. The method of claim 18, wherein the wireless sensor is configured to be operatively coupled with a bottle, and wherein said determining includes determining that the user behavioral action was performed if the companion motion is characterized by a tip angle that exceeds a threshold tip angle.

20. The method of claim 19, wherein said determining includes determining that the user behavioral action was performed if an elapsed time during which the tip angle exceeds the threshold tip angle is within a predetermined time range starting after the primary motion event is detected.

21. The method of claim 20, wherein the behavior data includes the elapsed time during which the tip angle exceeds the threshold tip angle.

22. The method of claim 18, wherein the wireless sensor is configured to be operatively coupled with a bottle cap, and wherein said determining includes determining that the user behavioral action was performed if the combination includes a cap removal action and a cap replacement action.

23. The method of claim 22, wherein said determining includes determining that the user behavioral action was performed if an elapsed time between the cap removal action and the cap replacement action is within a predetermined time range starting after the primary motion event is detected.

24. The method of claim 23, wherein the behavior data includes the elapsed time.

25. The method of claim 18, wherein said determining includes determining that the user behavioral action was performed if the primary motion event is characterized by a force that is less than a first predetermined shock force and if the companion motion is characterized by a force that is greater than a second predetermined shock force.

26. The method of claim 25, wherein said determining includes determining that the user behavioral action was performed if an elapsed time between the primary motion event and the companion motion is within a predetermined time range starting after the primary motion event is detected.

27. The method of claim 26, wherein the companion motion is a first companion motion, and wherein said determining includes determining that the user behavioral action was performed if a second companion motion having less than the first predetermined shock force is detected by the accelerometer within a second predetermined time range starting after the first companion motion is detected.

28. The method of claim 27, wherein the object includes a dental floss dispenser, wherein the primary motion event is characterized by a change in position of the dental floss dispenser from a rest position to a use position, and wherein the first companion motion is characterized by a floss snap event.
